(19) United States
(12) Patent Application Publication
(10) Pub. No.: US 2013/0104624 A1
(43) Pub. Date: May 2, 2013

(54) Measurement Circuit for a Breath Alcohol Device

(71) Applicant: Donovan Paul Devine, Durban (ZA)

(72) Inventor: Donovan Paul Devine, Durban (ZA)

(73) Assignee: PFK Electronics (Pty) Ltd., Durban (ZA)

(21) Appl. No.: 13/583,836

(22) PCT Filed: Mar. 9, 2011
(86) PCT No.: PCT/ZA11/00012

§ 371 Date: Oct. 25, 2012

(30) Foreign Application Priority Data
Mar. 10, 2010 (ZA) 2010/01696

(51) Int. Cl. G01N 27/42

(52) U.S. Cl. CPC G01N 27/42
USPC 73/23.3

(57) ABSTRACT

Measuring ethanol vapour concentration comprising; introducing an ethanol vapour sample into a fuel cell that is adapted to generate an output which is proportional to the ethanol vapour concentration of the ethanol sample; a voltage measurement circuit; a current measurement circuit; and means to switch the fuel cell output either to the voltage measurement circuit or to the current measurement circuit in dependence on one or more predetermined signal measurement parameters. The signal measurement parameter may be the temperature of the fuel cell.

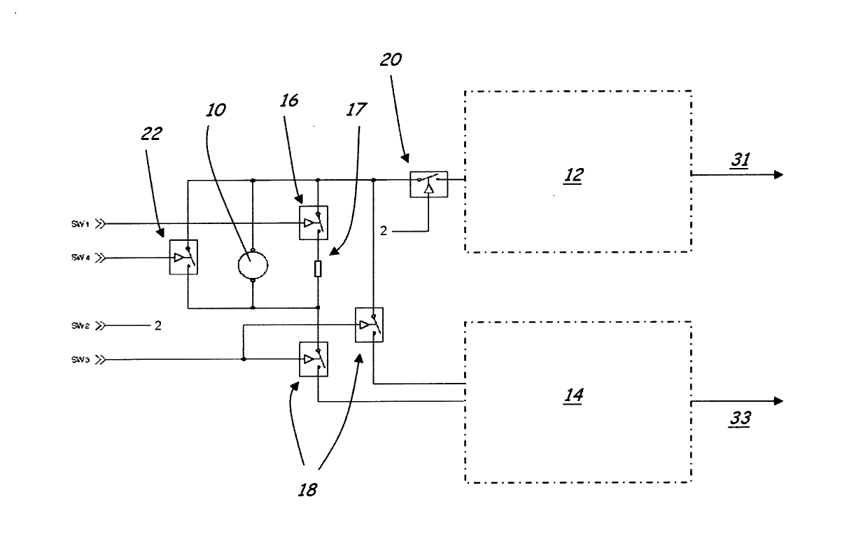

### FIELD OF THE INVENTION

The field of the invention is the measurement of breath alcohol concentration using voltage measurement or current measurement.

In particular the invention relates to a breath alcohol concentration measurement device and to a breath alcohol interlock device using such a measurement device.

### BACKGROUND TO THE INVENTION

The alcohol (or ethanol) sensors used in breath alcohol concentration measurement devices are normally constituted by electrochemical fuel cells in which a breath sample containing alcohol passed over the fuel cell generates a potential difference between the fuel cell electrodes, the potential difference being proportional to the concentration of the volatile component of the sample, which potential difference can be used to provide a quantitative ethanol vapour measurement.

To obtain meaningful results from such measurements, a fixed volume of sample gas is supplied to the fuel cell by means of a sampling system, such as a bellows device.

Conventional breath alcohol concentration measurement devices typically make use of one of two types of measurement technologies or modes. In some devices, the output of the alcohol sensor or electrochemical fuel cell is applied to a voltage measurement circuit and in others to a circuit that determines the current flow generated by the fuel cell, typically an integration circuit.

In devices using voltage measurement circuitry, the potential difference (voltage) across the fuel cell electrodes is measured directly, typically using a shunt resistor.

In devices using current flow measurement, the present methods of calculating current flow typically use either the peak height of the curve or, by integration, the area under the measured curve of the fuel cell output voltage as it rises, peaks and decays to a substantially steady minimum. U.S. Pat. No. 4,770,026—Wolf; Alcotek, Inc proposes integrating the entire area under the curve generated by the fuel cell output voltage between the beginning of oxidation of the alcohol in the fuel cell and the signal reaching a substantially steady minimum.

In current breath alcohol concentration measurement devices, signal integration techniques tend to be used as the measurement mode of choice, since these techniques most provide the most convenient, quick and repeatable measurement readouts in most operating conditions. Current fuel cell technology however, tends to yield variable results values for the same alcohol concentration if this measuring method is used at the upper end of the fuel cell operating temperature range (typically up to 85° C.).

Fuel cell technology also imposes a number of limitations on the universal use of peak voltage measurement techniques. The fuel cell output voltage peaks become lower with repeated use of the fuel cell. The peaks vary with temperature. Long fuel cell recovery times are often necessary and it is sometimes found that peak values for the same alcohol concentration decline with repeated use. Individual fuel cells differ in their characteristics. Fuel cells tend to slump with repeated use in quick succession and they degrade over time and must therefore be frequently re-calibrated. Eventually the fuel cell degrades to a point at which it must be replaced.

It is an object of this invention to address these shortcomings.

### SUMMARY OF THE INVENTION

According to this invention, a method is provided of measuring ethanol vapour concentration in a breath alcohol concentration measurement device that includes a fuel cell adapted to generate an output proportional to the ethanol vapour concentration of an ethanol vapour sample introduced into the fuel cell, a voltage measurement circuit, a current measurement circuit and means to switch the fuel cell output either to the voltage measurement circuit or to the current measurement circuit, the method comprising the steps of:
introducing an ethanol vapour sample into the fuel cell;
generating a fuel cell output which is proportional to the vapour concentration; and
in dependence on one or more predetermined signal measurement parameters, switching the fuel cell output either to a voltage measurement circuit or to a current measurement circuit.

In the voltage measurement circuit, the potential difference between the fuel cell electrodes may be measured directly or across a shunt resistor.

In the current measurement circuit, the current flow may be calculated or derived using one or more of the peak height of the fuel cell output curve or, by integration, the area under the curve.

In the latter embodiment of the invention, the current flow may conveniently be calculated or derived by means of integration of the area under the measured curve of the fuel cell output signal as it rises, peaks and decays to a substantially steady minimum.

The fuel cell output is preferably switched to the current measurement circuit by default and, in dependence on the predetermined signal measurement parameter or parameters, the fuel cell output is switched to the voltage measurement circuit.

The preferred signal measurement parameter is fuel cell temperature, the method comprising the specific steps of monitoring the fuel cell temperature and when, in use, the fuel cell temperature, as measured, falls below a predetermined temperature, switching the fuel cell output to the current measurement circuit and, when the fuel cell temperature, as measured, falls above the predetermined temperature, switching the fuel cell output to the voltage measurement circuit.

The invention includes apparatus for measuring ethanol vapour concentration, the apparatus comprising:
means to introduce an ethanol vapour sample into a fuel cell that is adapted to generate an output which is proportional to the ethanol vapour concentration of the ethanol sample;
a voltage measurement circuit;
a current measurement circuit; and
means to switch the fuel cell output either to the voltage measurement circuit or to the current measurement circuit in dependence on one or more predetermined signal measurement parameters.

The voltage measurement circuit is preferably a voltage measurement circuit adapted to measure the potential difference between the fuel cell electrodes directly or, more preferably, across a shunt resistor.

The current measurement circuit is preferably adapted to derive the current flow from the peak height of fuel cell output curve or, more preferably, by means of integration of the area under the measured fuel cell output voltage curve.

The apparatus of the invention preferably includes means to monitor the fuel cell temperature and switch means adapted, when in use, the fuel cell temperature, as measured by the temperature monitoring means, falls below a predetermined temperature, to switch the fuel cell output to the current measurement circuit and when in use, the fuel cell temperature, as measured by the temperature monitoring means, falls above the predetermined temperature, to switch the fuel cell output to the voltage measurement circuit.

The means to switch the fuel cell output may be constituted by configurable analog switches controlled by a microcontroller.

In the preferred form of the invention, the microcontroller is programmed to monitor and read the output from the fuel cell temperature sensor and to control the analog switches, in use, to switch the fuel cell output to the current measurement circuit and when the fuel cell temperature measured is above the predetermined temperature, to switch the fuel cell output to the voltage measurement circuit.

The predetermined temperature is preferably a set temperature within a temperature range between 40° C. and 90° C. and in a specific embodiment of the invention, the predetermined temperature is 85° C.

### BRIEF DESCRIPTION OF THE DRAWINGS

The invention will be further described with reference to the accompanying drawing which is a simplified block diagram of a device for measuring ethanol vapour concentration.

### DESCRIPTION OF EMBODIMENTS OF THE INVENTION

The ethanol vapour concentration device illustrated in the drawing forms part of an alcohol (or ethanol) sensor used in a breath alcohol concentration measurement device.

The device includes an electrochemical fuel cell 10 in which a breath sample containing alcohol passed over the fuel cell generates a potential difference between the fuel cell electrodes, the potential difference being proportional to the concentration of the volatile component of the sample, which potential difference can be used to provide a quantitative ethanol vapour measurement.

In some currently available breath alcohol concentration measurement devices, the output of the fuel cell is applied to a voltage measurement circuit and in others the fuel cell output is applied to an integration circuit that determines the current flow generated by the fuel cell.

In breath alcohol concentration measurement devices the fuel cell is required to work within a wide range of operating temperatures, ranging from hot to extremely cold.

In normal circumstances (normal room temperature operating conditions) it is best to measure the fuel cell output using the integration method, since the peak method suffers from the disadvantage that the peak fuel cell output decreases over time and does not have very good repeatability.

However, the integration method has its own disadvantages, notably the fact that the measuring method is not reliable at the high temperature end of the fuel cell operating temperature range due to the rapid evaporation of the alcohol sample at such temperatures.

The measurement circuit of this invention includes a current measurement circuit 12 and a voltage measurement circuit 14, to one or the other of which the output of a fuel cell 10 is applied in the alternate, in dependence on the measured fuel cell ambient temperature by means of a sensor (not shown).

By default, the fuel cell output is applied to the current measurement or signal integration circuit 12.

However, when the fuel cell ambient temperature, as measured, exceeds a predetermined temperature, the fuel cell output is switched to the voltage measurement circuit 14.

A set of configurable analog switches 16, 18-18, 20, 22 is controlled by a microcontroller (not shown) and a shunt resistor 17, with the microcontroller switch signals being applied as follows: SW1 to the first switch 16; SW2 to the second switch 20;), SW3 to the third switch 18-18; and SW4 to the fourth switch 20.

With the first and third switches 16 and 18-18 closed, the output from the terminals of the fuel cell 10 is applied to the voltage measurement circuit 14.

With the second switch 20 ON, the fuel cell 10 output is applied to the integration circuit 12, the latter being the default setting.

A fourth switch 22, when closed, will simply create a short circuit across the fuel cell terminals, thereby reducing the voltage to zero. This is useful in re-initialising the fuel cell 10 after use, the microcontroller being programmed to hold the short circuit for a predetermined period long enough to allow the fuel cell 10 to recover after each use.

With the first and third switches 16 and 18-18 open and the second switch 20 closed (the default setting), the fuel cell 10 output is applied to a conventional current measurement circuit 12 in which current flow through the fuel cell 10 is calculated by means of integration of the area under the measured output curve of the circuit 12. The signal constituted by the calculated value is output at 31 to the microcontroller.

With the first and third switches 16 and 18-18 closed and the second switch 20 open, the fuel cell output is applied to a conventional voltage measurement circuit 14 in which the potential difference (preferably the peak value) across the fuel cell electrodes is measured directly and a measured value is output at 33 to the microcontroller.

The default measurement mode of the ethanol vapour concentration device of the invention is current measurement or signal integration by means of the current measurement circuit 12 and only when the fuel cell temperature rises above the predetermined temperature is the fuel cell output switched to the voltage measurement circuit 14.

The fuel cell ambient temperature sensor (not shown) forming part of the device circuitry is adapted to monitor the fuel cell temperature and when, in use, the fuel cell temperature, as measured, is below a predetermined temperature, the microcontroller will apply the fuel cell output to the current measurement or signal integration circuit 12.

However, when the fuel cell temperature, as measured, rises above the predetermined temperature, the microcontroller will switch the fuel cell output to the voltage measurement circuit 14.

The predetermined temperature is preferably set to fall within a temperature range of between 40° C. and 90° C., the preferred temperature setting being 85° C. In such an embodiment of the invention, therefore, if the fuel cell temperature, as measured, is below 85° C., the microcontroller will apply the fuel cell output to the current measurement or signal integration circuit 12 and if the fuel cell temperature, as measured, rises above 85° C., the microcontroller will switch the fuel cell output to the voltage measurement circuit 14.

What is claimed is:

1. A method of measuring ethanol vapour concentration in a breath alcohol concentration measurement device that includes a fuel cell adapted to generate an output proportional to the ethanol vapour concentration of an ethanol vapour sample introduced into the fuel cell, a voltage measurement circuit, a current measurement circuit and means to switch the fuel cell output either to the voltage measurement circuit or to the current measurement circuit, the method comprising the steps of:
introducing an ethanol vapour sample into the fuel cell;
generating a fuel cell output which is proportional to the vapour concentration; and
in dependence on one or more predetermined signal measurement parameters, switching the fuel cell output either to a voltage measurement circuit or to a current measurement circuit.

2. The method of measuring ethanol vapour concentration according to claim 1, further comprising, in the voltage measurement circuit, measuring the potential difference between the fuel cell electrodes directly.

3. The method of measuring ethanol vapour concentration according to claim 1, further comprising, in the voltage measurement circuit, measuring the potential difference between the fuel cell electrodes across a shunt resistor.

4. The method of measuring ethanol vapour concentration according to claim 1, further comprising, in the current measurement circuit, calculating the current flow using one or more of the peak height of the fuel cell output curve or, by integration, the area under the curve.

5. The method of measuring ethanol vapour concentration according to claim 4, further comprising, in the current measurement circuit, calculating the current flow by means of integration of the area under the measured curve of the fuel cell output signal as it rises, peaks and decays to a substantially steady minimum.

6. The method of measuring ethanol vapour concentration according to claim 1, further comprising switching the fuel cell output to the current measurement circuit by default and, in dependence on the predetermined signal measurement parameter or parameters, switching the fuel cell output to the voltage measurement circuit.

7. The method of measuring ethanol vapour concentration according to claim 1, wherein one of the predetermined signal measurement parameters is fuel cell temperature, the method further comprising the specific steps of monitoring the fuel cell temperature and when, in use, the fuel cell temperature, as measured, falls below a predetermined temperature, switching the fuel cell output to the current measurement circuit and, when the fuel cell temperature, as measured, falls above the predetermined temperature, switching the fuel cell output to the voltage measurement circuit.

8. Apparatus for measuring ethanol vapour concentration, the apparatus comprising:
means to introduce an ethanol vapour sample into a fuel cell that is adapted to generate an output which is proportional to the ethanol vapour concentration of the ethanol sample;
a voltage measurement circuit;
a current measurement circuit; and
means to switch the fuel cell output either to the voltage measurement circuit or to the current measurement circuit in dependence on one or more predetermined signal measurement parameters.

9. The apparatus for measuring ethanol vapour concentration according to claim 8, wherein the voltage measurement circuit is a voltage measurement circuit adapted to measure the potential difference between the fuel cell electrodes directly.

10. The apparatus for measuring ethanol vapour concentration according to claim 8, wherein the voltage measurement circuit is adapted to measure the potential difference between the fuel cell electrodes across a shunt resistor.

11. The apparatus for measuring ethanol vapour concentration according to claim 8, wherein the current measurement circuit is adapted to derive the current flow from the peak height of fuel cell output curve.

12. The apparatus for measuring ethanol vapour concentration according to claim 8, wherein the current measurement circuit is adapted to derive the current flow by means of integration of the area under the measured fuel cell output voltage curve.

13. The apparatus for measuring ethanol vapour concentration according to claim 8, further comprising means to monitor the fuel cell temperature and switch means adapted, when in use, the fuel cell temperature, as measured by the temperature monitoring means, falls below a predetermined temperature, to switch the fuel cell output to the current measurement circuit and when in use, the fuel cell temperature, as measured by the temperature monitoring means, falls above the predetermined temperature, to switch the fuel cell output to the voltage measurement circuit.

14. The apparatus for measuring ethanol vapour concentration according to claim 8, wherein the means to switch the fuel cell output is constituted by configurable analog switches controlled by a microcontroller.

15. The apparatus for measuring ethanol vapour concentration according to claim 14, wherein the microcontroller is programmed to monitor and read the output from a fuel cell temperature sensing means and to control the analog switches, in use, to switch the fuel cell output to the current measurement circuit and when the fuel cell temperature, as measured, is above the predetermined temperature, to switch the fuel cell output to the voltage measurement circuit.

16. The apparatus for measuring ethanol vapour concentration according to claim 8, wherein the predetermined temperature is a set temperature within a temperature range between 40° C. and 90° C.

17. The apparatus for measuring ethanol vapour concentration according to claim 16, wherein the predetermined temperature is 85° C.

18. The apparatus for measuring ethanol vapour concentration according to claim 13, wherein the microcontroller is programmed to monitor and read the output from a fuel cell temperature sensing means and to control the analog switches, in use, to switch the fuel cell output to the current measurement circuit and when the fuel cell temperature, as measured, is above the predetermined temperature, to switch the fuel cell output to the voltage measurement circuit.

19. The method of measuring ethanol vapour concentration according to claim 5, further comprising switching the fuel cell output to the current measurement circuit by default and, in dependence on the predetermined signal measurement parameter or parameters, switching the fuel cell output to the voltage measurement circuit.

20. The method of measuring ethanol vapour concentration according to claim 3, further comprising, in the current measurement circuit, calculating the current flow using one or more of the peak height of the fuel cell output curve or, by integration, the area under the curve.
